(19) United States
(12) Patent Application Publication
(10) Pub. No.: US 2015/0116074 A1
(43) Pub. Date: Apr. 30, 2015

(54) RHEOSTAT

(71) Applicants: HON HAI PRECISION INDUSTRY CO., LTD., New Taipei (TW); HONG FU JIN PRECISION INDUSTRY (ShenZhen) CO. LTD., Shenzhen (CN)

(72) Inventor: SHENG-YI LI, Shenzhen (CN)

(73) Assignees: HON HAI PRECISION INDUSTRY CO., LTD., New Taipei (TW); HONG FU JIN PRECISION INDUSTRY (ShenZhen) CO. LTD., Shenzhen (CN)

(21) Appl. No.: 14/178,175

(22) Filed: Feb. 11, 2014

(30) Foreign Application Priority Data
Oct. 31, 2013 (CN) 2013105261179

(51) Int. Cl. H01C 10/50

(52) U.S. Cl. CPC H01C 10/50
USPC 338/200

(57) ABSTRACT

A rheostat includes a connection port, a variable resistor, a controller and a display. The connection port is electrically connected to a computer and configured for receiving a control signal of the computer. The variable resistor is electrically connected to a circuit board. The controller is electrically connected to the connection port and the variable resistor and is configured for changing a resistance value of the variable resistor according to the control signal. The display is electrically connected to the controller and displaying the resistance value.

### BACKGROUND

1. Technical Field

The present disclosure relates to a rheostat.

2. Description of Related Art

When designing a new electronic device, it a resistance value of a resistor of the electronic device needs to be changed. Conventionally, an old resistor should be removed and a new resistor should be soldered on a circuit board of the electronic device each time changing the value of resistance. It is inconvenient and the circuit board may be damaged after repeated removing and soldering different resistors.

Therefore, it is desirable to provide rheostat which can overcome the shortcomings mentioned above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a functional block diagram of a rheostat according to an exemplary embodiment of the present disclosure.

FIG. 2 is a circuit diagram of a connection port of the rheostat of FIG. 1.

FIG. 3 is a circuit diagram of a controller of the rheostat of FIG. 1.

FIG. 4 is a circuit diagram of a variable resistor of the rheostat of FIG. 1.

FIGS. 5-7 are circuit diagrams of manual adjustment switch modules of the rheostat of FIG. 1.

FIG. 8 is a circuit diagram of a display of the rheostat of FIG. 1.

FIG. 9 is a circuit diagram of an indicating lamp module of the rheostat of FIG. 1.

### DETAILED DESCRIPTION

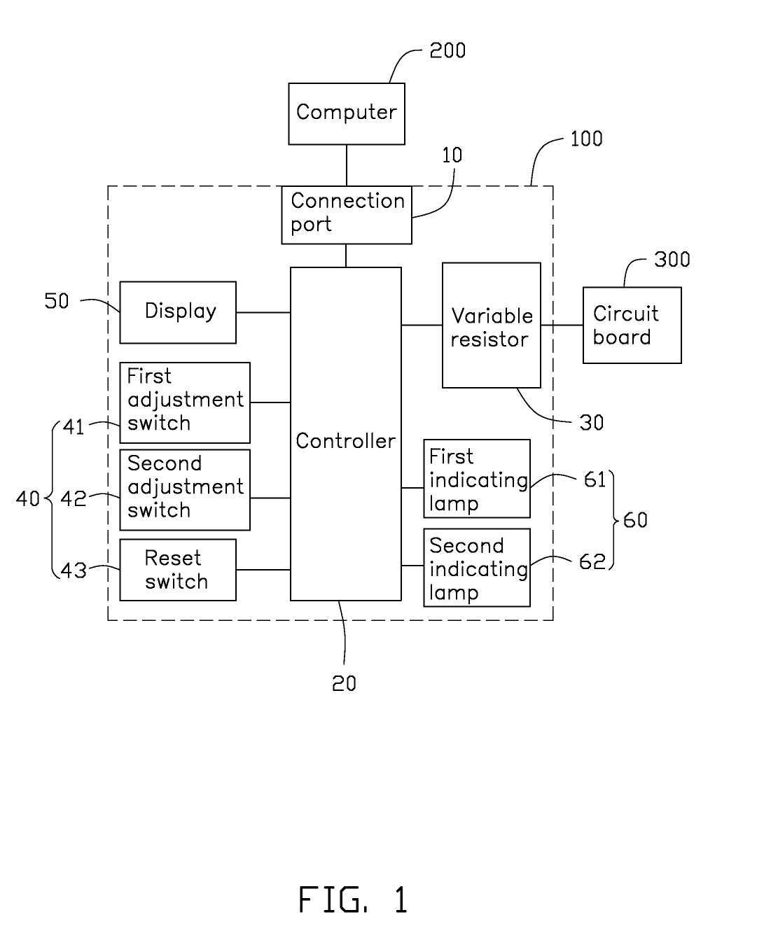

FIG. 1 shows a rheostat 100 according to an exemplary embodiment of the present disclosure. The rheostat 100 includes a connection port 10, a controller 20, a variable resistor 30, a manual adjustment switch module 40, a display 50, and an indicating lamp module 60.

The connection port 10 is electrically connected to a computer 200 and receives control signals from the computer 200. The connection port 10 further receives a voltage signal from the computer 200 and supplies power to the controller 20, the variable resistor 30, the display 50, and the indicating lamp module 60. In this embodiment, the connection port 10 is a universal serial bus (USB) port.

The controller 20 is electrically connected to the connection port 10 and the variable resistor 30. The controller 20 receives the control signals from the connection port 10, and converts the control signals to signals distinguishable by the variable resistor 30, and controls the variable resistor 30 to operate. The controller 20 is a single chip microcomputer (SCM). In this embodiment, the controller 20 is CY7C64215-28PVXC.

The variable resistor 30 is electrically connected to a circuit board 300 to be tested, and can change resistance values under control of the controller 20. In this embodiment, the variable resistor 30 is MAX5483 and the variable resistor 30 can distinguish serial peripheral interface (SPI) signals.

The adjustment switch module 40 is electrically connected to the controller 20. The controller 20 can change the resistance value of the variable resistor 30 according to an output signal of the manually adjusted adjustment switch module 40. The adjustment switch module 40 includes a first adjustment switch 41, a second adjustment switch 42 and a reset switch 43. The first adjustment switch 41 is used to increase the resistance value of the variable resistor 30. The second adjustment switch is used to reduce the resistance value of the variable resistor 30. The reset switch 43 is used to recover the resistance value of the variable resistor 30 to a primary value. In this embodiment, the first adjustment switch 41, the second adjustment switch 42, and the reset switch 43 are SW4-ODD-7 switches.

The display 50 is electrically connected to the controller 20 and displays the resistance value of the variable resistor 30. The display 50 can further display a highest resistance value of the variable resistor 30, a lowest resistance value of the variable resistor 30, an adjustment step (resistance values changed per each adjustment) of the first adjustment switch 41, and an adjustment step of the second adjustment switch 42. In this embodiment, the display is 1602LCD, and the adjustment step of the first adjustment switch 41 is equal to the adjustment step of the second adjustment switch 42. In other embodiments, only one adjustment switch can be used to replace both the first adjustment switch 41 and the second adjustment switch 42, when the adjustment switch is turned clockwise, the resistance value of the variable resistor 30 increases, and when the adjustment switch is turned counterclockwise, the resistance value of the variable resistor 30 decreases.

The indicating lamp module 60 is electrically connected to the controller 20 and is used to indicate a working state of the variable resistor 30. The indicating lamp module 60 includes a first indicating lamp 61 and a second indicating lamp 62. The first indicating lamp 61 shows that the variable resistor 30 is working in a normal state. The second indicating lamp 62 shows that the variable resistor 30 is working in an abnormal state, such as a resistance value input from the computer 200 is exceeding the highest or lowest resistance values of the variable resistor 30. The first adjustment switch 41 is manually operated when the resistance value of the variable resistor 30 reaches the highest resistance value. The second adjustment switch 42 is manually operated when the resistance value of the variable resistor 30 reaches the lowest resistance value. In this embodiment, the first indicating lamp 61 is a green light emitting diode (LED), and the second indicating lamp 62 is a yellow LED.

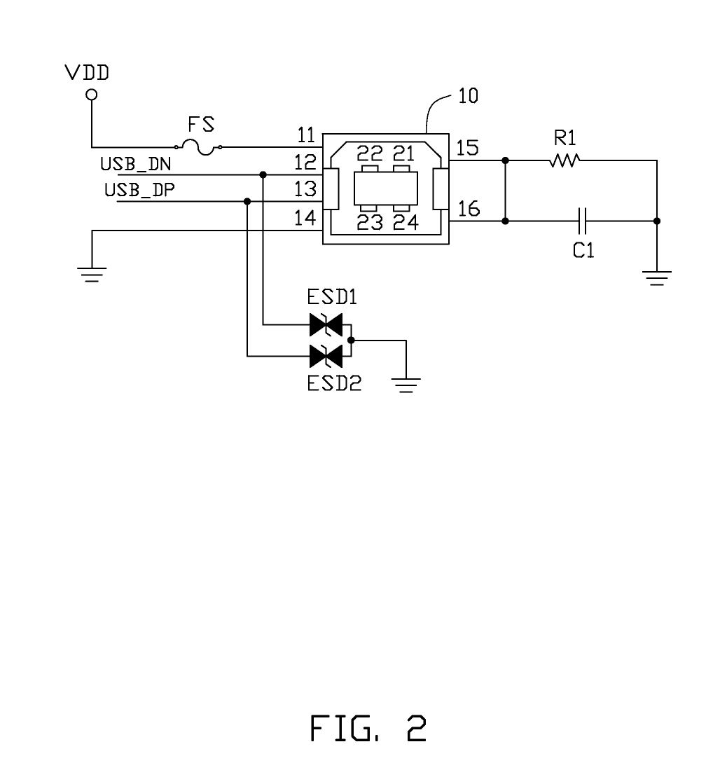

FIG. 2 shows the connection port 10. The connection port 10 includes a voltage terminal connected to an external power source VDD through an over current protecting component FS. A digital terminal 12 grounded through a static protecting component ESD1 and electrically connected to a digital terminal D− of the controller 20. A digital terminal 13 grounded through a static protecting component ESD2 and electrically connected to a digital terminal D+ of the controller 20. Pins 15, 16 are electrically connected to each other and grounded through parallel connection with a capacitor C1 and a resistor R1, and digital terminals 21, 22, 23, 24 electrically connected to the computer 200.

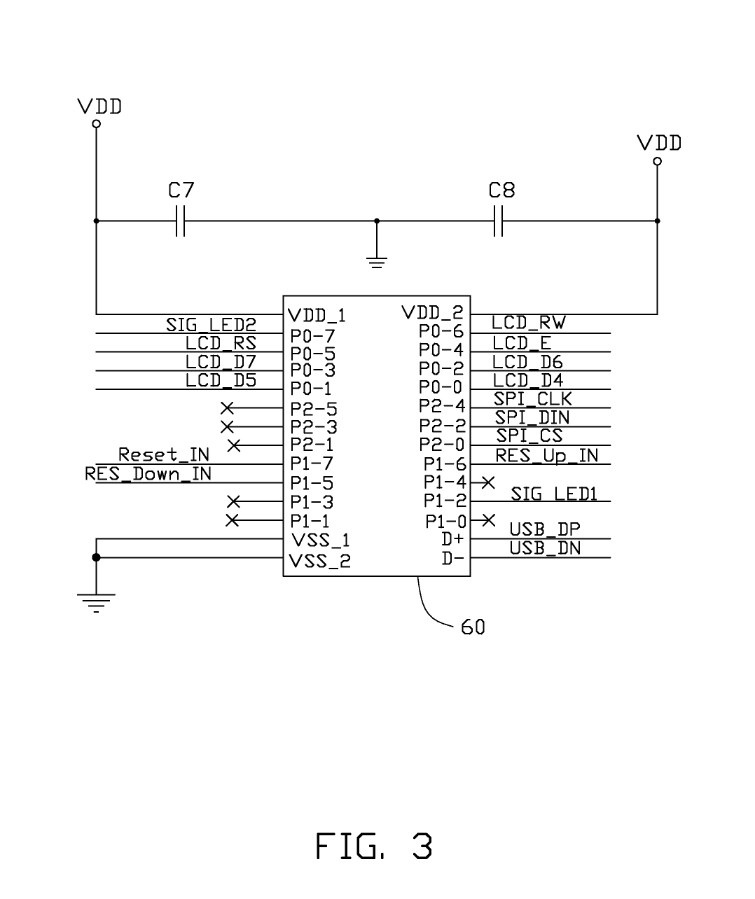

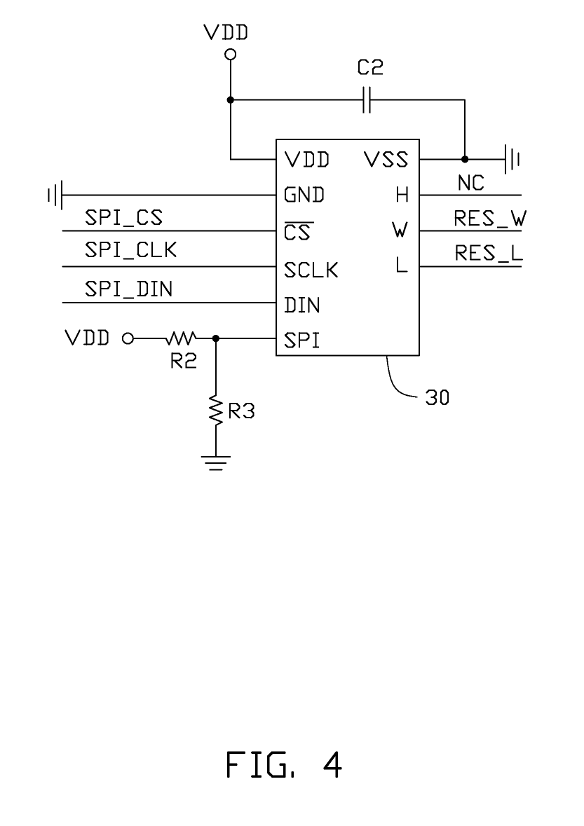

FIGS. 3 and 4 show the controller 20 and the variable resistor 30. The variable resistor 30 includes a voltage terminal electrically connected to the external power source VDD and grounded through a capacitor C2, grounded ground terminals VSS, GND, signal output terminals H, W, L electrically connected to the circuit board 300, a chip selecting terminal CS electrically connected to an input/output (I/O) pin P2-0, a clock signal terminal SCLK electrically connected to an I/O pin P2-4, a digital terminal DIN electrically connected to an I/O pin P2-2, and an enable terminal SPI electrically connected to the external power source VDD through a resistor R2 and grounded through a resistor R3.

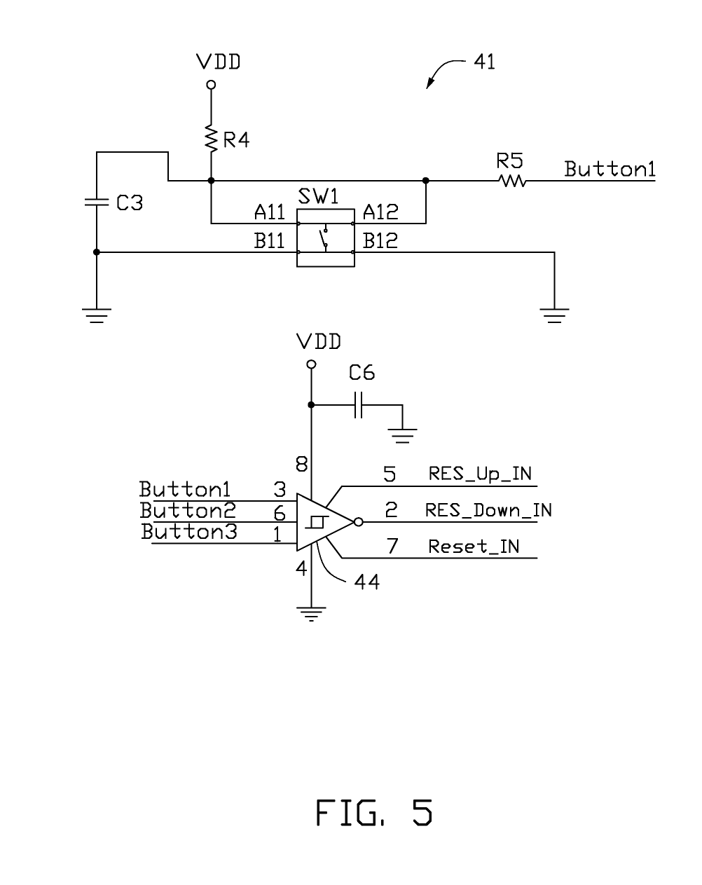

FIG. 5 shows the first adjustment switch 41. The first adjustment switch 41 includes a first switch SW1. The first switch SW1 includes four first output terminals A11, A12, B11, B12. The first output terminal A11 is electrically connected to the first output terminal A12 through a first conductive line. The first output terminal B11 is electrically connected to the first output terminal B12 through a second conductive line. When the first switch SW1 closes, the first conductive line is electrically connected with the second conductive line. When the first switch SW1 opens, the first conductive line is electrically disconnected with the second conductive line. The first output terminal A11 is electrically connected to the external power source VDD through a resistor R4 and is grounded through a capacitor C3. The first output terminal A12 is electrically connected to an input terminal 3 of a reverser 44 having a Schmitt trigger through a resistor R5. The first output terminals B11 and B12 are grounded.

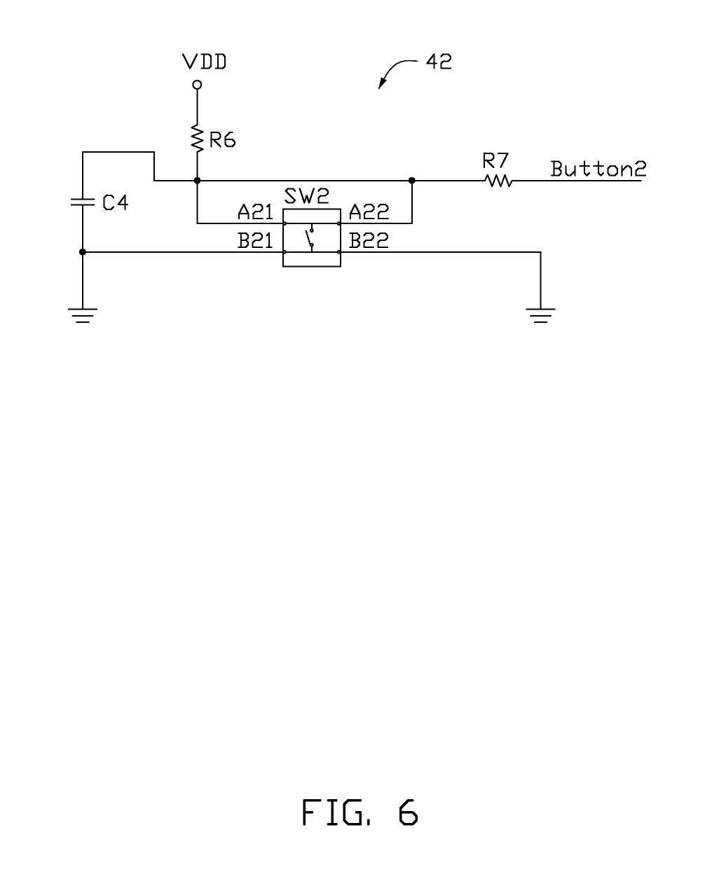

FIG. 6 shows the second adjustment switch 42. The second adjustment switch 42 includes a second switch SW2. The second switch SW2 includes four second output terminals A21, A22, B21, B22. The second output terminal A21 is electrically connected to the second output terminal A22 through a third conductive line. The second output terminal B21 is electrically connected to the second output terminal B22 through a fourth conductive line. When the second switch SW2 closes, the third conductive line is electrically connected with the fourth conductive line. When the second switch SW2 opens, the third conductive line is electrically disconnected with the fourth conductive line. The second output terminal A21 is electrically connected to the external power source VDD through a resistor R6 and is grounded through a capacitor C4. The second output terminal A22 is electrically connected to an input terminal 6 of the reverser 44 through a resistor R7. The second output terminals B21 and B22 are grounded.

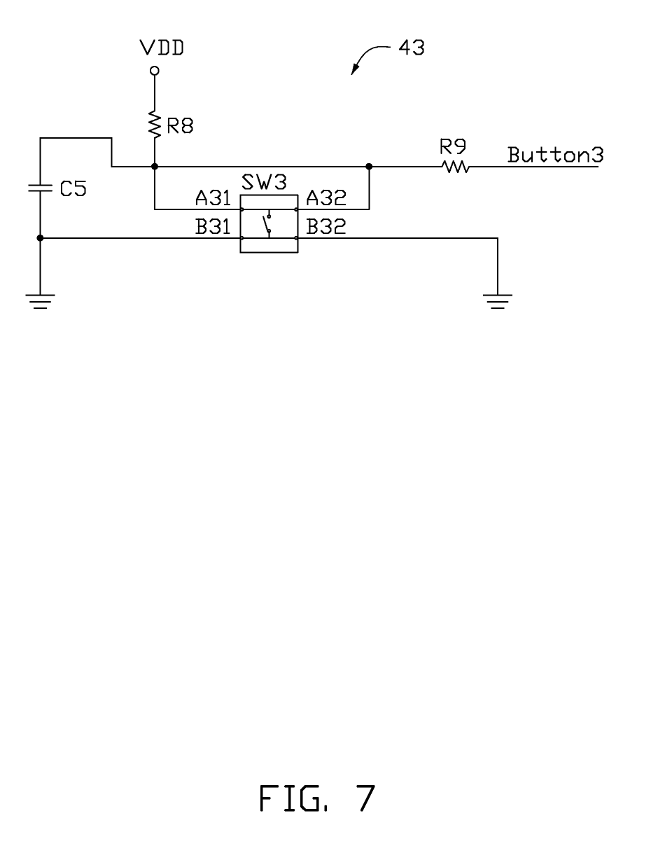

FIG. 7 shows the reset switch 43. The reset switch 43 includes a third switch SW3. The third switch SW3 includes four third output terminals A31, A32, B31, B32. The third output terminal A31 is electrically connected to the third output terminal A32 through a fifth conductive line. The third output terminal B31 is electrically connected to the third output terminal B32 through a sixth conductive line. When the third switch SW3 closes, the fifth conductive line is electrically connected with the sixth conductive line. When the third switch SW3 opens, the fifth conductive line is electrically disconnected with the sixth conductive line. The third output terminal A31 is electrically connected to the external power source VDD through a resistor R8 and is grounded through a capacitor C5. The third output terminal A32 is electrically connected to an input terminal 1 of the reverser 44 through a resistor R9. The third output terminals B31 and B32 are grounded.

The reverser 44 includes a voltage terminal 8 grounded through a capacitor C6 and electrically connected to the external power source VDD. A grounded ground terminal 4, an output terminal 5 electrically connected to an I/O pin P1-6 of the controller 20 and configured for outputting a RES-UP-IN signal for increasing the resistance value of the variable resistor 30 to the controller 20. An output terminal 2 electrically connected to an I/O pin P1-5 of the controller 20 and configured for outputting a RES-DOWN-IN signal for decreasing the resistance value of the variable resistor 30 to the controller 20. In addition, an output terminal 7 electrically connected to an I/O pin P1-7 of the controller 20 and configured for outputting a Reset-IN signal for resetting the resistance value of the variable resistor 30 to the controller 20.

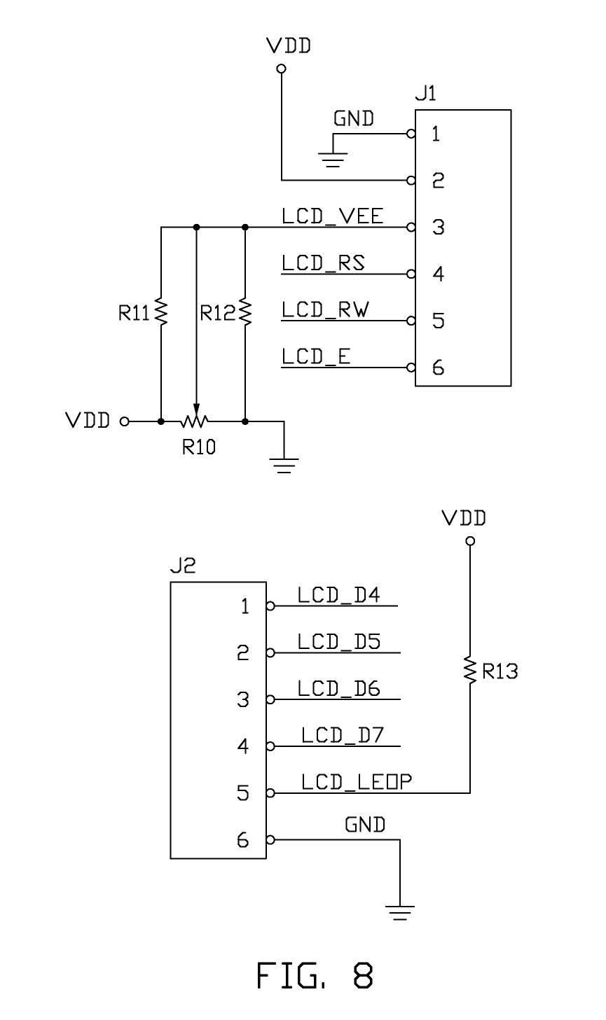

FIG. 8 shows the display 50. The display 50 is electrically connected to the controller 20 through the connectors J1 and J2. The connector J1 includes a voltage terminal electrically connected to the external power source VDD, a grounded ground terminal 1, a digital terminal 3 electrically connected to a slide resistor R10, electrically connected to the external power source VDD through a resistor R11, and grounded through a resistor R12. A digital terminal 4 electrically connected to an I/O pin P0-5 of the controller 20, a digital terminal 5 electrically connected to an I/O pin P0-6 of the controller 20, and a digital terminal 6 electrically connected to an I/O pin P0-4 of the controller 20. The slide resistor R10 includes an end electrically connected to the external power source VDD and the resistor R11, and another end electrically connected to the resistor R12 and grounded.

The connector J2 includes a grounded ground terminal 6, a digital terminal 1 electrically connected to an I/O pin P0-1 of the controller 20, a digital terminal 3 electrically connected to an I/O pin P0-2 of the controller 20, a digital terminal 4 electrically connected to an I/O pin P0-3 of the controller 20, and a voltage terminal 5 electrically connected to the external power source VDD through a resistor R13.

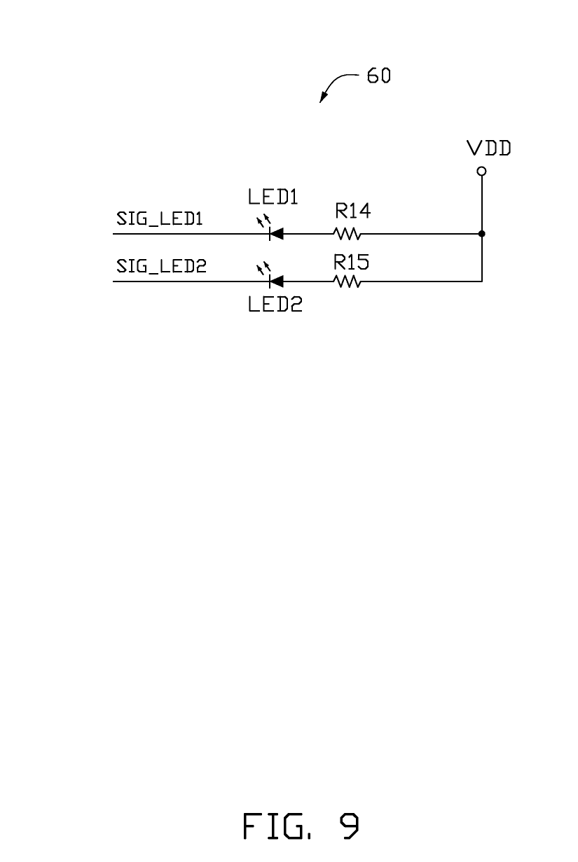

FIG. 9 shows the indicating lamp module 60. The first indicating lamp 61 includes a LED1 and a resistor R14. The second indicating lamp 62 includes a LED2 and a resistor R15. An end of the LED1 is electrically connected to an I/O pin P1-2 of the controller 20, another end of the LED1 is electrically connected to the external power source VDD through a resistor R14. An end of the LED2 is electrically connected to an I/O pin P0-7 of the controller 20, another end of the LED2 is electrically connected to the external power source VDD through a resistor R15. The resistor R14 is used to control a brightness of the LED1, the resistor R15 is used to control a brightness of the LED2.

FIG. 3 shows that the controller 20 further includes a voltage terminal VDD-1 grounded through a capacitor C7 and electrically connected to the external power VDD. A voltage terminal VDD-2 grounded through a capacitor C8 and electrically connected to the external power VDD, grounded ground terminals VSS-1 and VSS-2, and idle I/O pins P1-0, P1-1, P1-3, P1-4, P2-1, P2-3, and P2-5.

The resistance value of the rheostat 100 can be adjusted conveniently, thus, there is no need for replacing resistors on the circuit board 300, and the working life of the circuit board 300 is prolonged.

It will be understood that the above particular embodiments are shown and described by way of illustration only. The principles and the features of the present disclosure may be employed in various and numerous embodiments thereof without departing from the scope of the disclosure. The above-described embodiments illustrate the scope of the disclosure but do not restrict the scope of the disclosure.

What is claimed is:

1. A rheostat comprising:
a connection port electrically connected to a computer and configured for receiving a control signal of the computer;
a variable resistor electrically connected to a circuit board;
a controller electrically connected to the connection port and the variable resistor and configured for changing a resistance value of the variable resistor according to the control signal; and
a display electrically connected to the controller and displaying the resistance value.

2. The rheostat of claim 1, wherein the connection port further converts the control signal to a distinguishable of the variable resistor.

3. The rheostat of claim 1, wherein the display further displays a highest resistance value and a lowest resistance value of the variable resistor.

4. The rheostat of claim 1, wherein the controller is a single chip microcomputer (SCM) and comprises digital terminals, the connection port comprises two digital terminals electrically connected to digital terminals of the controller, the variable resistor comprises a chip selecting terminal, a clock signal terminal, and a digital terminal respectively electrically connected to the controller, and the variable resistor comprises signal outputting terminals electrically connected to the circuit board.

5. The rheostat of claim 1, further comprising a manual adjustment switch module electrically connected to the controller, wherein the controller is capable of changing the resistance value under the control of the manual adjustment switch.

6. The rheostat of claim 5, wherein the manual adjustment switch comprises a first adjustment switch, a second adjustment switch and a reset switch, the first adjustment switch is configured for increasing the resistance value, the second adjustment switch is configured for decreasing the resistance value, and the reset switch is configured for recovering the resistance value to a primary resistance value.

7. The rheostat of claim 6, wherein the display further displays an adjustment step of the first adjustment switch and an adjustment step of the second adjustment switch.

8. The rheostat of claim 6, wherein the first adjustment switch comprises a first switch, the second adjustment switch comprises a second switch, the reset switch comprises a third switch, the first switch, the second switch, and the third switch respectively comprises an output terminal, the rheostat further comprises a reverser comprising a Schmitt trigger, the reverser comprising a first input terminal electrically connected to the output terminal of the first switch, a first output terminal electrically connected to the controller and configured for outputting a signal of increasing the resistance value, a second input terminal electrically connected to the output terminal of the second switch, a second output terminal electrically connected to the controller and configured for outputting a signal of decreasing the resistance value, a third input terminal electrically connected to the output terminal of the third switch, a third output terminal electrically connected to the controller and configured for outputting a signal of recovering the resistance value to the primary resistance value.

9. The rheostat of claim 1, further comprising an indicating lamp module for indicating a working state of the variable resistor.

10. The rheostat of claim 9, wherein the indicating lamp module comprises a first indicating lamp configured for indicating that the variable resistor is working in a normal state, and a second indicating lamp configured for indicating that the variable resistor is working in an abnormal state.
